(19) United States
(12) Patent Application Publication
(10) Pub. No.: US 2016/0251880 A1
(43) Pub. Date: Sep. 1, 2016

(54) CONTROL FOR VEHICLE CLOSURES

(71) Applicant: ADAC PLASTIC, INC., Grand Rapids, MI (US)

(72) Inventors: Robert Bingle, Walker, MI (US); Jerry Cummins, Portland, MI (US); Thomas Merlyn French, Rockford, MI (US); Tyler John Marvin, Caledonia, MI (US); Bruce C. Banter, Northville, MI (US)

(21) Appl. No.: 15/143,596

(22) Filed: May 1, 2016

Related U.S. Application Data
(63) Continuation-in-part of application No. 14/215,465, filed on Mar. 17, 2014.
(60) Provisional application No. 61/787,287, filed on Mar. 15, 2013.
(60) Provisional application No. 62/156,159, filed on May 1, 2015.
(60) Provisional application No. 62/159,071, filed on May 8, 2015.

(51) Int. Cl. B60R 25/23

(52) U.S. Cl. CPC E05B 81/77; B60R 25/23

(57) ABSTRACT

A user-actuatable vehicle closure control, comprising at least one force sensing member disposed beneath at least one force transfer member, the at least one force sensing member operative to detect the application of force thereto, and the force transfer member moveable upon user application of force thereto so as to transfer the user-applied force to the at least one force sensing member; and a controller operatively connected to the at least one force sensing member, the controller operative to direct the execution of one or more pre-defined vehicle commands in response to one or more signals from the at least one force sensing member indicating the application of force thereto by a user via the force transfer member.

### CROSS-REFERENCE TO RELATED APPLICATIONS

The present application is a continuation-in-part of U.S. patent application Ser. No. 14/215,465, filed 17 Mar. 2014, and through which priority is claimed to U.S. Provisional Application Ser. No. 61/787,287, filed 15 Mar. 2013, the disclosures of which applications are incorporated herein by reference in their entireties.

The present application also claims the benefit of priority from U.S. Provisional Application Ser. No. 62/156,159, filed 1 May 2015, and U.S. Provisional Application Ser. No. 62/159,071, filed 8 May 2015, the disclosures of which applications are incorporated herein by reference in their entireties.

### FIELD OF THE INVENTION

The present invention relates to user-actuatable controls for vehicle closures, such as may be incorporated into a vehicle handle or trim component to facilitate actuating a door, lift gate, trunk, etc., and more specifically to such controls which are operative via the detected application of force to one or more sensors.

### BACKGROUND OF THE INVENTION

Handles for vehicle closures often utilize electro-mechanical switches or capacitive sensors to determine user interaction with the handle surface in order to initiate unlock/lock commands, input access codes via a keypad in the handle, etc.

While electro-mechanical switches are advantageous because of low cost and low drain on the vehicle's power system, they do have several drawbacks, including the following: First, electro-mechanical switches may include moveable buttons and actuators for a user to interact with. Yet, current handle design aesthetics favor “clean” surfaces with minimal gaps or disruptions. Second, only limited information about a user's interaction with the electro-mechanical switch can be obtained. Typically, for instance, only open and closed states of the switch can be determined. Third, the typical actuation forces required of electro-mechanical switches are around 8 Newtons, with travel distances typically being relatively great at at least 1.0 mm. Lower actuation forces and/or travel distances are difficult to design with electro-mechanical switches. Fourth, electro-mechanical switches can be difficult to seal with respect to the environment outside of the vehicle. Failed sealing can result in contamination or oxidation of the switch contacts, which in turn may result in switch failure. Fifth, electro-mechanical switches require tuning of the mechanical movement to achieve a desired “feel” for the user and to eliminate “button wobble.” Sixth, the life of the mechanism is limited by the moving elements thereof. Seventh, 10 mS or more of contact “de-bounce” time is required to acquire a reliable state or output in the switch.

Capacitive sensors, by comparison, measure the change in a capacitive field generated on the touch surface. But while these sensors have their own advantages, they also have drawbacks, including the following: First, capacitive sensors have difficulty sensing covered (e.g., gloved) hands. Second, capacitive sensors have trouble discriminating between intended and inadvertent contacts, sometimes yielding an undesired effect (such as an unintended vehicle unlocking/locking). Third, capacitive sensors can be erroneously activated by water (such as from rain, car washes, etc.). Fourth, any conductive metal placed on the sensing surface can be interpreted as a touch. Fifth, touches on individual areas of the sensor cannot be distinguished from each other; the sensor can only determine whether or not contact has been made. Sixth, electromagnetic interference can be erroneously interpreted as a touch. Seventh, the long response time (>200 mS) often programmed into capacitive sensor systems to discriminate between a true touch and a false signal can be an annoyance to users desiring a more rapid response time.

### SUMMARY OF THE DISCLOSURE

Disclosed herein is a user-actuatable control for a vehicle closure, comprising: at least one force sensing member disposed beneath at least one force transfer member, the at least one force sensing member operative to detect the intensity of forces applied thereto, and the at least one force transfer member moveable upon user application thereto of one or more forces so as to transfer the one or more user-applied forces to one or more locations on the at least one force sensing member; and a controller operatively connected to the at least one force sensing member. The controller operates to: map the location and intensity of each of the one or more user-applied forces as detected by the at least one force sensing member; compare the mapped location and intensity information received from the at least one force sensing member to pre-defined force profiles, each pre-defined force profile corresponding to at least one pre-defined vehicle command; and direct the execution of one or more of the pre-defined vehicle commands when the mapped location and intensity information received from the at least one force sensing member corresponds to a pre-defined force profile associated with a vehicle command.

Per one feature, the vehicle command is selected from the group consisting of unlatching one or more of the vehicle's doors, turning on one or more of the vehicle's interior lights, turning on one or more of the vehicle's exterior lights, starting the car's engine, turning off one or more of the vehicle's interior lights, turning off one or more of the vehicle's exterior lights, recognition of at least a portion of an access code, and unlocking one or more of the vehicle's doors.

According to another feature, each at least one force sensing member is one of a strain gage, an optical sensor, an infra-red sensor, or a force sensing resistor.

Per still another feature, the vehicle door control is embodied in a door handle having front and rear surfaces. In one form, the at least one force transfer member is provided proximate each of the front and rear surfaces of the handle, and the at least one force sensing member operates to detect the intensity of forces applied thereto via each force transfer member. In one form, the at least one force transfer member comprises a resiliently deformable portion that is deflectable from an undeformed state thereof by a known amount in response to the application of a given amount of force, and the at least one force sensing member comprises a strain gage operative to measure the amount of deflection in the resiliently deformable portion from the undeformed state.

Per yet another feature, the controller comprises a printed circuit board. The printed circuit board may comprise one or more LEDs. Furthermore, the controller may operate to direct the selective illumination of one or more of the one or more LEDs when the mapped location and intensity information received from the at least one force sensing member corresponds to a pre-defined force profile associated with a vehicle command.

According to a still further feature, the at least one force transfer member comprises a resiliently deformable portion that is deflectable from an undeformed state thereof by a known amount in response to the application of a given amount of force, and the at least one force sensing member comprises an infra-red beam operative to measure the amount of deflection in the resiliently deformable portion from the undeformed state.

According to yet another feature, the at least one force sensing member comprises a plurality of force sensing resistors disposed in a regular array to define a plurality of predefined coordinates, and the controller is operative to map the location and intensity of each of the one or more user-applied forces using the predefined coordinates. In one form, the force transfer member comprises a deformable material which is directly contacted by a user, and the array of force sensing resistors are disposed directly adjacent the deformable material. The deformable material may have indicia provided thereon, the indicia including one or more of numbers, letters and symbols representing one or more vehicle commands. The closure control may be embodied in one of a vehicle door handle, the B-pillar of a vehicle, or the exterior surface of a vehicle door.

Per a still further feature, the at least one force sensing member comprises a plurality of force sensing resistors; and the at least one force transfer member comprises a plurality of mechanical elements which are selectively moveable between first and second positions, each mechanical element contacting at least one of the force sensing resistors in the second position thereof, and each mechanical element being biased to the first position thereof.

According to yet another feature, the at least one force sensing member comprises a plurality of force sensing resistors, and the at least one force transfer member comprises a deformable component including one or more projections facing the at least one force sensing member. Each projection is arranged so as to be able to contact the at least one force sensing member as the at least one force transfer member is deformed. In one form, the one or more projections each extend to one of a plurality of distances from the deformable component. The plurality of distances may be the same, different, or a combination thereof. In one form, at least two of the plurality of distances are different.

According to another feature, a haptic device may be operatively connected to the control. The controller may further operate to actuate the haptic device to provide physical feedback to a user upon the application of force to the at least one force transfer member.

Per a further feature, the pre-defined force profiles each correspond to a plurality of locations and intensities of user-applied forces. In one form, each set of the plurality of intensities and locations of the user-applied forces for each pre-defined force profile define an activation threshold. In one form, the activation threshold for each pre-defined force profile is learned by the controller and corresponds to a particular set of locations and intensities of forces applied by a user to the force transfer member for the given force profile.

Per another feature, the pre-defined force profiles include at least two distinct sets of force profiles associated with at least two distinct users. The controller operates to associate each distinct force profile set with a unique code associated with a distinct key fob carried by each distinct user, and to use only the force profile set associated with the unique code detected.

In one embodiment, there is disclosed a user-actuatable vehicle closure control comprising at least one force sensing member disposed beneath at least one force transfer member, the at least one force sensing member operative to detect the application of force thereto, and the force transfer member moveable upon user application of force thereto so as to transfer the user-applied force to the at least one force sensing member; and a controller operatively connected to the at least one force sensing member, the controller operative to direct the execution of one or more pre-defined vehicle commands in response to one or more signals from the at least one force sensing member indicating the application of force thereto by a user via the force transfer member.

According to one embodiment, the force transfer member is a trim component. The trim component may be movably mountable to a closure so as to be capable of being temporarily pressed or pushed by a user toward the closure from a first position. The at least one force sensing member comprises at least one sensor button positioned on a surface of the trim component facing the closure so as to detect the application of force thereto when the trim component is temporarily pressed or pushed by a user toward the closure. An housing is mountable on an interior surface of the closure, the housing containing the controller. The controller is connectable to a power source and operatively connectable to a latch mechanism for the closure, and the controller is also operatively connected to the at least one sensor button so as to receive the one or more signals indicating the application of force to the at least one sensor button. The controller is operative, in response to one or more signals from the at least one sensor button indicating the application of force thereto by a user via the trim component, to at least effect actuation of the closure latch mechanism.

In one embodiment, the closure is a trunk closure and the trim component is a decorative emblem for the trunk closure.

According to one feature of the present invention, the trim component is biased into the first position.

Per another feature, the controller may comprise a printed circuit board.

According to a further feature, each at least one sensor button may comprise a piezoelectric sensor.

Per a still further feature, a resiliently compressible gasket may be mountable between the trim component and the closure, the gasket having a shape complimentary to the trim component so as to be substantially hidden thereby.

According to another feature, the one or more signals from the at least one sensor button comprise signals of varying duration according to the duration of the force applied thereto via movement of the trim component toward the closure. The one or more pre-defined vehicle commands include unique commands associated with the one or more signals according to their duration. For instance, the controller may be operative to effect unlatching of the closure latch mechanism in response to signals of a first duration, and to effect placing the closure latch mechanism in a locked state in response to signals of a second duration which is different than the first duration.

Per another feature, the one or more pre-defined vehicle commands include unique commands associated with the one or more signals according to the sequence in which the one or more signals are received by the controller. For instance, the controller may be operative to effect unlatching of the closure latch mechanism in response to the first signal received after the closure latch mechanism is in a locked state, and to effect placing the closure latch mechanism in a locked state in response to the first signal received after the closure latch mechanism is unlatched.

In one embodiment, the vehicle closure control comprises one or more lights operatively connected to, and selectively illuminated by, the controller. The one or more lights may, per one form of the invention, be illuminated when the controller directs the execution of one or more of the pre-defined vehicle commands.

Per another feature, the one or more lights are capable of illumination in more than one color; the controller is programmed to effect selective illumination of one or more different colors for each of distinct ones of the pre-defined vehicle commands. For instance, the controller may be operative to effect illumination of the one or more lights in a first color when the controller has effected unlatching of the closure latch mechanism, and to effect illumination of the one or more lights in a second color that is different from the first color when the controller has effected placing the closure latch mechanism in a locked state.

Per one embodiment, the one or more lights are associated with a light-transmitting member positioned adjacent the trim component. The light-transmitting member may be substantially disposed on a surface of the trim component facing the closure, and the one or more lights may be disposed in the housing and associated with the light-transmitting member to as to convey illumination to the light-transmitting member.

According to another embodiment, the closure control further comprises one or more speakers operatively connected to the controller. The controller is programmed to effect selective emission of an audible signal from the one or more speakers for each of distinct ones of the pre-defined vehicle commands.

### BRIEF DESCRIPTION OF THE DRAWINGS

The foregoing and other features and advantages of the present invention may be better understood with reference to the specification and accompanying drawings, of which:

FIGS. 1a through 1c depict various positions of contact between a user and a vehicle door handle;

FIG. 2 is a simplified cross-sectional view of a vehicle door handle according to one embodiment of the invention, wherein strain relief gages are employed as force sensing members;

FIG. 3 is a simplified depiction of an array of FORCE SENSING RESISTORS;

FIGS. 4a and 4b are simplified views of a vehicle closure control utilizing a FORCE SENSING RESISTOR array;

FIG. 5 is a perspective view of a vehicle door handle incorporating the closure control of the present invention;

FIG. 6 is a simplified cross-sectional view of a vehicle door handle according to one embodiment of the invention, wherein FORCE SENSING RESISTORS are employed as force sensing members;

FIG. 7 is a simplified cross-sectional view of a vehicle door handle according to another embodiment of the invention, wherein FORCE SENSING RESISTORS are employed as force sensing members;

FIG. 8 is a simplified cross-sectional view of a vehicle door handle according to a still further embodiment of the invention, wherein FORCE SENSING RESISTORS are employed as force sensing members; and

FIG. 9 is a simplified cross-sectional view of a vehicle door handle according to a yet another embodiment of the invention, wherein FORCE SENSING RESISTORS are employed as force sensing members.

FIG. 10 is a perspective view of a vehicle trunk closure incorporating a closure control according to an embodiment of the present invention;

FIG. 11 is an exploded perspective view of the closure control according to the embodiment of FIG. 10;

FIG. 12 is a simplified cross-sectional view showing the closure control according to the embodiment of FIG. 10;

FIG. 13 is a perspective view, taken from an interior of the trunk closure, of the closure control according to the embodiment of FIG. 10; and

FIG. 14 is a further perspective view, taken from an interior of the trunk closure, of the closure control according to the embodiment of FIG. 10.

FIG. 15 shows an alternative embodiment of the closure control, wherein illumination proximate the force transferring member provides a visual indication of operation of the closure control.

### DETAILED DESCRIPTION

Referring now to the drawings, wherein like numerals indicate like or corresponding parts throughout the several views, there is disclosed in several embodiments a user-actuatable vehicle closure control comprising at least one force sensing member disposed beneath at least one force transferring member. The at least one force sensing member is operative to detect the intensity of forces applied thereto, and the at least one force transferring member is moveable upon user application thereto of one or more forces so as to transfer the one or more user-applied forces to one or more locations on the at least one force sensing member. A controller is operatively connected to the at least one force sensing member. The controller is operative to receive information from the at least one force sensing members and to map the location and intensity of the one or more user-applied forces detected by the at least one force sensing member, to compare the mapped data to pre-defined force profiles, and to direct the execution of one or more pre-defined vehicle commands when the mapped data correspond to a pre-defined force profile associated with a vehicle command.

As explained further below, the at least one force sensing member may, by way of non-limiting example, be one or more strain gages, one or more optical sensors, one or more infra-red sensors, one or more FORCE SENSING RESISTORS, or “FSRs” (Interlink Electronics, Inc., Camarillo, Calif. USA), or one or more piezoelectric sensors. As known to those skilled in the art, a piezoelectric sensor is a device that uses the piezoelectric effect to measure changes in pressure, acceleration, strain or force by converting those changes into an electrical charge.

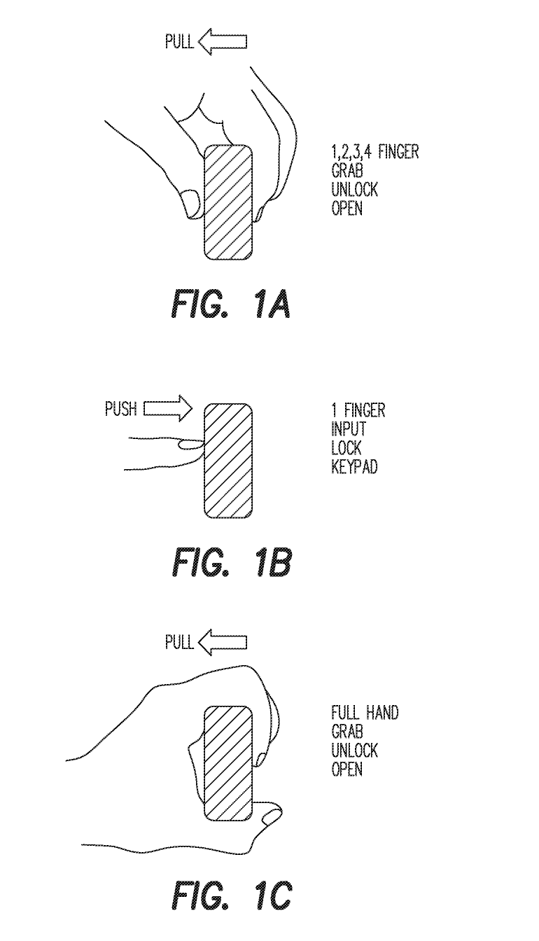

Referring to FIGS. 1a through 1b, the present invention permits the force of a user's intended input to be measured for intensity and duration to distinguish it from an inadvertent application of force to the vehicle closure control, a false signal, etc. According to the embodiments described herein, the vehicle closure control is more particularly a vehicle door handle or vehicle trunk closure. However, it will be appreciated, with the benefit of this disclosure, that the present invention may be adapted to other forms, and that the embodiments particularly described herein are only exemplary.

By mapping the location and intensity of the applied forces, and comparing such mapped information against pre-defined “force profiles”—that is, pre-defined profiles of forces of varying intensities and their locations—the present invention permits users to communicate different intentions by varying the intensity and/or location of force(s) applied to the vehicle closure control. Thus, for example and without limitation, force profiles can be defined which correspond to: a user's intent to open the vehicle door by contacting both front and rear surfaces of the door handle with multiple fingers or the entire hand (FIGS. 1a and 1c); and a user's intent to enter a vehicle access or security code by contacting only a keypad disposed at the front surface of the handle (FIG. 1b). Upon mapping the location and intensity of the one or more user-applied forces detected by the at least one force sensing member, and comparing the mapped data to the pre-defined force profiles, the controller is operative to direct the execution of one or more pre-defined vehicle commands when the mapped data correspond to a pre-defined force profile associated with a vehicle command (such as, for instance, unlocking the vehicle's door(s), turning on exterior and/or interior lights, etc.).

As will be appreciated with the benefit of this disclosure, “force profiles” may be defined for any of a variety of user applied forces of various locations and intensities. Preferably, though not necessarily, such force profiles and the pre-defined vehicle commands associated therewith will correspond to the most natural application of user force to the handle (or other closure control interface) to be associated with the desired vehicle command event. So, for instance, the application of force to a front surface of the handle would be associated with a user's intent to enter a security code via a keypad rather than, for instance, an intention to open (as opposed to simply unlocking) the vehicle door. Conversely, a user's application of force to front and rear surfaces of the handle simultaneously would be associated with a user's intent to actuate the handle in order to open the vehicle door, as opposed to an intent to enter an access or security code via a keypad.

It will be appreciated that the present invention permits a greater variety of user intentions to be determined and translated into vehicle commands, since sensing both the location and intensity of one or more user-applied forces yields more information about the user's intentions than can be obtained, for instance, from the capacitive type sensors or electro-mechanical switches more commonly employed in many vehicle closure control systems. Further, the present invention will be understood to minimize, or even eliminate, the inadvertent effecting of vehicle commands occasioned by false signals (such as caused by moisture, interference, etc.), particularly as vehicle commands can be associated with mapped user interactions that are more easily distinguishable (by reason of intensity of force and location) from conventional false signals.

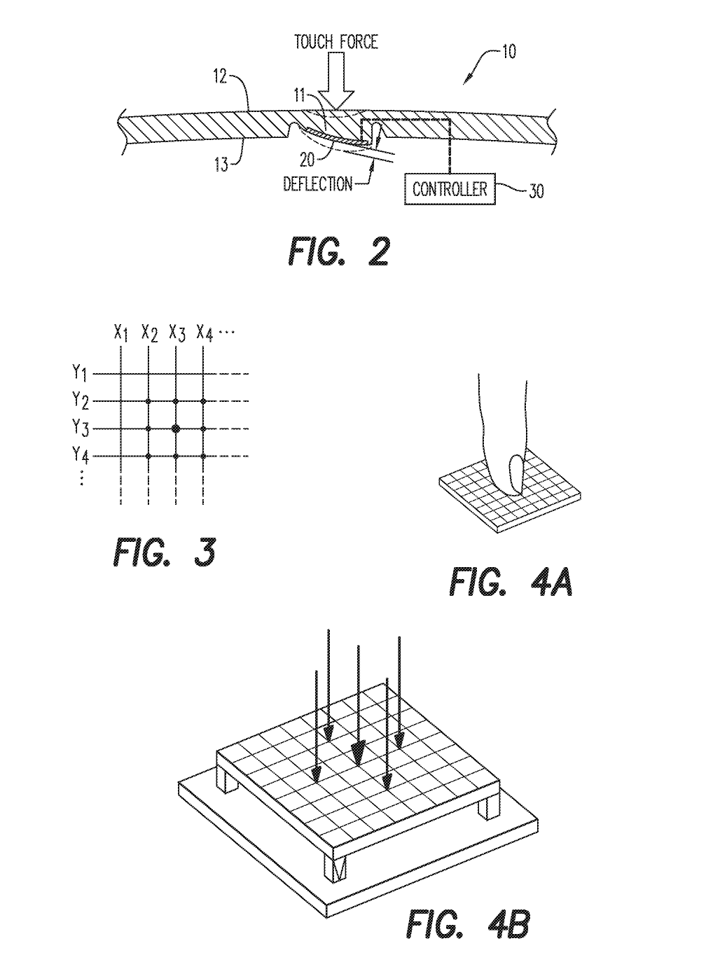

Referring now to FIG. 2, the invention according to one embodiment may take the form of a vehicle door handle 10 (shown in simplified cross-section) incorporating at least one strain gage 20 as a force sensing member. According to this embodiment, the handle 10 includes a resiliently deformable portion 11 that is at least partially constructed from a material that is temporarily deformable upon the application of force thereto by a user. Each deformable portion 11 is selected to deflect by a known amount in response to a given amount of force applied thereto. Positioned in or adjacent to each deformable portion 11 is at least one strain gage 20 of conventional construction. Each strain gage 20 is operative to measure the amount of deflection, or strain, in the resiliently deformable portion 11 from the undeformed state thereof, depending upon the degree of deformation thereof (which, in turn, is a consequence of the amount of force applied thereto). Accordingly, each resiliently deformable portion 11 will be understood to define the force transferring member of the invention.

The controller 30, operatively connected to the at least one strain gage 20 (shown by the dashed line) maps the location and intensity of the one or more user-applied forces transferred via the resiliently deformable portion 11 and detected by the each strain gage 20 and, compares that mapped data to pre-defined force profiles, and, when the mapped data corresponds to a pre-defined “force profile”, directs the execution of one or more pre-defined vehicle commands corresponding to the determined “force profile.” While the controller is shown schematically in FIG. 2, it will be appreciated that the controller may comprise a printed circuit board (“PCB”) or the like disposed within the handle or, alternatively, disposed elsewhere in the vehicle.

As will be apparent from the foregoing, the handle 10 of FIG. 2 may be constructed to include multiple resiliently deformable portions 11 and associated strain gages 20, each positioned to correspond to areas on the handle that will be subject to user applied forces. These areas may include front 12 (i.e., facing away from the vehicle door) and rear 13 (i.e., facing toward the vehicle door) surfaces of the handle and, more specifically, may include areas corresponding to alphanumeric “keys” on a keypad defined on or adjacent to a surface of the handle.

In a variant of the foregoing embodiment, deflection or deformation of the temporarily deformable portion 11 of the handle 10 may be detected by an infra-red beam (not shown) that is broken by the resiliently deformable portion 11 in response to a user-applied force, or by an infra-red beam (not shown) that is reflected against a surface of the deformable portion (or a reflective material provided thereon). In either case, the infra-red beams define the force-sensing members, whereas the resiliently deformable material of the handle itself constitutes the force transferring member.

Turning now to FIGS. 3 through 8, there are shown embodiments of the present invention wherein the force sensing member or members comprise FORCE SENSING RESISTORS, or FSRs (Interlink Electronics, Inc., Camarillo, Calif.). In one exemplary form, FORCE SENSING RESISTORS include a sensing film comprising electrically conducting and non-conducting particles suspended in a matrix. The particles change resistance in a predictable manner following the application of force to the film's surface. More particularly, applying a force to the surface of the sensing film causes particles to touch the conducting electrodes, changing the resistance of the film. Further, a small applied force can generate a large resistance change for a low signal-to-noise ratio.

Conventionally, FSRs can be printed on flexible substrates or applied to plastic surfaces.

According to the embodiments of the invention described below, a plurality of FSRs can be disposed in a regular array, such as a grid. (See FIG. 3.) This grid defines a plurality of coordinates (X₁, Y₁; X₁, Y₂; X₂, Y₁; etc.) which the controller, operatively connected to the FSR array, is operative to map in location and intensity as user applied forces (e.g., finger touches) are detected at any of the various points on the FSR array. In this fashion, the invention is operative to generate a “force profile” of applied pressure over the area of the FSR.

Furthermore, an FSR array can be fashioned so as to sense applied forces on two opposite faces thereof. As will be appreciated from this disclosure, such an array can be positioned to detect the intensity and location of user-applied inputs on each of the opposite faces, which may be disposed so as to face opposite (front and rear) surfaces of a vehicle handle.

In one embodiment of the invention, shown in FIGS. 4a and 4b, the FSR array can be placed directly adjacent to the touch surface, which may be the front surface of a vehicle handle, a surface of the vehicle door panel, the B-pillar of the vehicle, etc. According to this embodiment, the force transferring member may be a deformable material on which may be provided (such as via printing or the like) indicia (such as numbers, letters, etc.) for entering a security or access code for locking/unlocking the vehicle, effecting pre-defined actions (locking/unlocking the vehicle, etc.), etc.

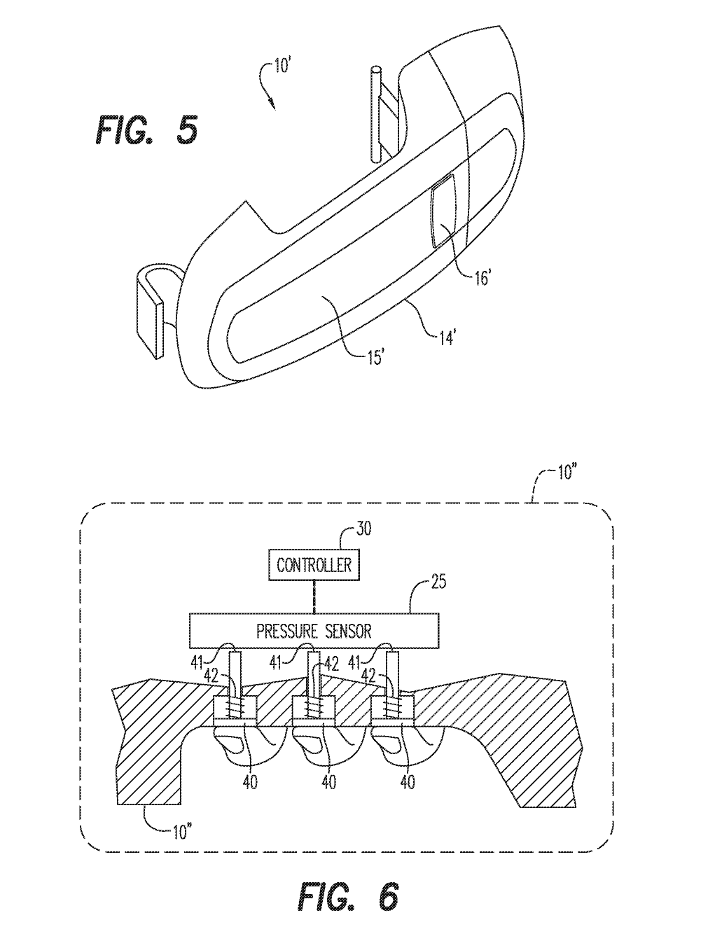

Turning to FIGS. 5 through 9, there are shown several embodiments of the present invention employing FSRs such as described above.

In the first such embodiment, shown in FIG. 5, it is contemplated that the switch or switches 16′ in existing vehicle handle designs, such as the handle 10′ exemplified in FIG. 5, may be replaced with the control of the present invention, according to which a controller and FSRs are disposed in the handle 10′, with the FSRs being sealed from the outside environment by a resiliently deformable material defining the user-contacted portion of the switch and, thus, the force transferring member.

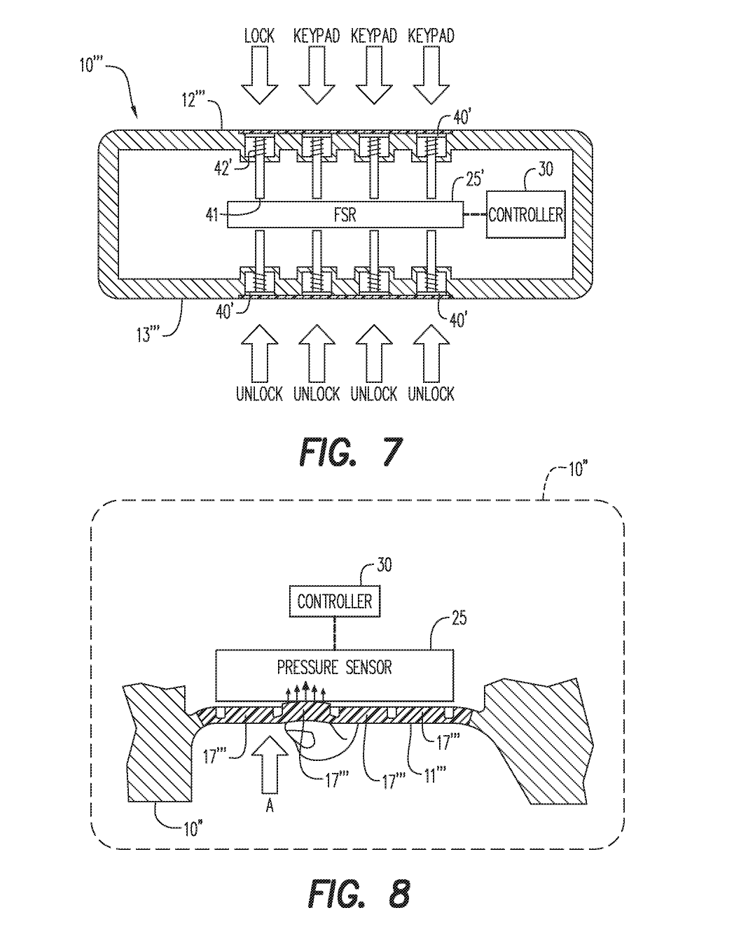

In the second embodiment, shown in FIGS. 6 and 7, the force transmitting members may comprise discrete, mechanical elements, such as the illustrated spring-biased keys or plungers 40, which are mounted in the door handle 10″ so as to be accessible to the user. As will be appreciated, keys or plungers 40 may be sealed from the exterior of the handle, such as by the provision of a resiliently deformable plastic layer overlying the keys, etc. Alternatively, they may be exposed to the exterior of the handle body, and sealed with respect thereto via gaskets, etc. As shown, each plunger or key 40 includes a contact end 41 which contacts an underlying FSR 25 to convey the intensity of a user-applied force to the FSR. As shown, a plurality of keys or plungers 40 are provided, each being biased by a spring 42 or other biasing means to a default state in which each key or plunger is out of contact with the FSR.

According to the illustrated embodiment, the controller 30 is operative to receive (shown by the dotted line) from the FSR information respecting the location of each plunger or keys 40 contact therewith, as well as the intensity of the force transferred thereby, to map the location and intensity of the one or more user-applied forces, to compare the mapped data to pre-defined force profiles, and to direct and to direct the execution of one or more pre-defined vehicle commands depending upon the mapped location and intensity of the one or more user-applied forces as detected by the FSR. More specifically, it is contemplated that at least user actuation of each key or plunger 40 corresponds to a defined vehicle command and, moreover, that one or more combinations of user actuation of each key or plunger 40 also correspond to defined vehicle commands. So, by way of example only, the actuation of each plunger or key 40 separately may correspond to the entry of a component (e.g., number or letter) of a security code entered via a keypad, the actuation of all plungers or keys 40 simultaneously may correspond to a command to unlock the vehicle, and the simultaneous actuation of various combinations of two of the keys or plungers 40 may correspond to various other vehicle commands.

Referring specifically to FIG. 7, there is shown a variant of the foregoing embodiment in which the force sensing member 25′—the FSR—comprises FSR sensors disposed on opposite surfaces thereof. According to this embodiment, keys or plungers 40′ are provided on both of the front 12 and rear 13 surfaces of the vehicle handle 10′″. As will be appreciated, the provision of user-actuatable keys or plungers 40′ on each surface of the handle provides a greater variety of vehicle commands that can be effected. So, for example, a plurality of the keys or plungers 40′ provided on the front surface of the handle may correspond to the various keys of a keypad (designated by the arrows labeled “Key Pad”) for entry of a vehicle access code, as well as a separate “lock” key (designated by the arrows labeled “Lock”) for effecting locking of the vehicle. Also for example, the detected actuation of keys or plungers 40′ provided on the rear surface 13′″ of the handle may correspond to a command to unlatch and/or unlock the vehicle door (as designated by the arrows labeled “Unlock”).

Referring next to FIG. 8, there is shown an embodiment of the present invention where the force transferring member comprises a resiliently deformable component of the vehicle handle 10″″, such as a flexible beam 11″″ or other deformable member, incorporated into the handle surface. According to this embodiment, user application of force to the force transferring component deforms that component and urges it into contact (in the direction of arrow A) with the underlying FSR 25 at one or more locations. The detected location and intensity of this contact, as mapped by the controller 30, is translated into vehicle commands in the manner as heretofore described. The one or more locations of potential contact between the deformable component can be defined by various projections 17″″ of the same or varying heights defined on the underside of the deformable component 11″″—that is, the side of the deformable component facing the FSR 25.

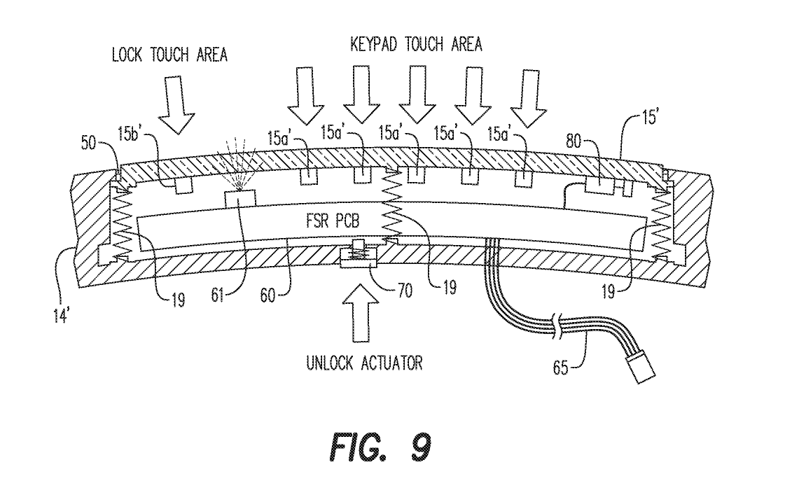

In one form, depicted in FIG. 9, the force transferring member may take the form of a moveable and resiliently deformable component, such as the illustrated lens 15′ forming part of the vehicle door handle (see FIG. 5). Of course, the lens 15′ is only exemplary, and it will be understood that the moveable and resiliently deformable component may be one or more other components of the vehicle or vehicle door handle, including, by way of non-limiting example, handle trim components.

Still more particularly, lens may be seen to be movably mounted on handle body member 14′ with an FSR sensor array disposed there-beneath. Lens 15′ is captured in handle body 14′ so as not to be removable therefrom. Lens 15′ is biased, such as by springs 19′ or other biasing means, into a default position in which lens does not contact the FSR sensor. A sealing gasket 50 may be disposed between the periphery of lens 15′ and handle body 14′ to seal the interior area against the external environment, the ingress of moisture, etc. According to the embodiment particularly illustrated, handle body 14′ comprises only a portion of the handle 10′ (exemplified in FIG. 5), and more specifically a cover portion which overlies a separate base portion of the handle (not shown). As depicted, handle body 14′ defines an internal space beneath the lens 15′. The FSR (described further below) is disposable in that space.

The underside of lens 15′ includes a plurality of projections 15a′, each of which may contact the FSR array in response to movement and deformation of the lens 15′ upon application of force thereto by a user. The arrangement of projections 15a′ will be understood to correspond to a desired map of location-effected vehicle commands. For instance, the lens 15′ may include indicia defining a “key-pad,” with projections 15a′ arranged beneath those indicia so that, upon user applied force on various ones of the indicia corresponding to a pre-defined access code for the vehicle, corresponding locations on the FSR array will be contacted by the projections 15a′. The lens 15′ may further define a “lock button” location with a corresponding projection 15b′. The projections 15a′, 15b′ may be formed as part of the lens 15′, or may be formed separately and physically connected thereto.

User-applied force at the “lock button” is translated to the FSR by local movement or deformation of the lens 15′, while the sensed contact between the projections 15a′, 15b′ and FSR is translated by the controller as a pre-defined command to lock the vehicle.

Consistent with the foregoing, it is understood that the lens is made of a material that exhibits, upon the application of force thereto by a user, a degree of deformability or deflection suitable to operation in the manner herein described.

FSR array may be provided on a printed circuit board (“PCB”) also comprising the controller. PCB 60 may also include one or more LEDs 61 for selectively illuminating the lens 15′, including, for instance, in response to contact between any one or more of the projections 15a′, 15b′ and the FSR. The PCB 60 is coupled, such as through a wiring harness 65, to a power source in the vehicle, as well as one or more other controllers, such as the vehicle's body control module, for effecting, in otherwise known fashion, the vehicle commands as determined by the controller. Alternatively, or in addition, it will be appreciated that PCB 60 may also be locally programmed with the pre-defined vehicle commands, or some of them, and operative to effect those commands when the mapped location and intensity information received from the at least one force sensing member corresponds to a pre-defined force profile associated with a vehicle command.

Wiring harness 65 may also convey signals from elsewhere in the vehicle for effecting actions at the handle such as, by way of example, illumination of the LED to indicate when the vehicle is in a locked or unlocked state.

Also per the embodiment of FIG. 9, the FSR sensor portion of the PCB 60 is double-sided in the form as described hereinabove, with one sensing surface facing the front of the handle and the other sensing surface facing the rear of the handle. There is, moreover, provided a spring-biased plunger 70 extending through the body 14′ and projecting outwardly toward the interior of the handle (not depicted). Plunger 70 operates much like the keys or plungers described elsewhere herein, and is positioned to contact the FSR, in response to deformation of the handle core upon a user's grabbing the rear surface of the handle. According to the illustrated embodiment, such contact is mapped by the controller as corresponding to a pre-defined action to unlock the vehicle. Per this embodiment, it will be appreciated that the handle core includes a deformable portion which is deformed or deflected upon a user's application of pressure thereto, which deformable portion in turn contacts the plunger 70 to effect the translation of the user-applied force to the FSR.

Still further, a haptic actuator 80 may be provided to give user feedback, such as a physical vibration of the lens 15′, upon a user's application of force to the lens 15′. The haptic actuator 80 may, for instance, be electrically connected to the PCB 60.

According to one variant, one or more piezoelectric sensors may be substituted for the various sensors and gages described herein, including in the embodiments described below. As those skilled in the art will appreciate, piezoelectric sensors share attributes with FSR sensors but, unlike FSR sensors which may be characterized as responding to a defined pressure input, piezoelectric sensors respond to a defined change in applied pressure. This characteristic has been found to be advantageous in respect of the applications herein disclosed. FSR sensors must be incorporated within handles, trim components, etc. with fairly precise tolerances so that when, for instance, a handle is actuated with the application of a force meeting a predefined threshold (e.g., 5N), that force is translated to the controller to effect a preprogrammed response. If, however, a handle assembly is out of tolerance and a space or gap is present between the handle and the FSR sensor, the applied force may need to exceed the predefined threshold of 5N to overcome the gap that is present from the tolerance error. Conversely, if the handle is built with the tolerance on the tight side (e.g., no gap or interference fit), then the FSR sensor may trigger the preprogrammed response well below the predefined threshold.

With piezoelectric sensors, on the other hand, the predefined threshold need only be a change in an applied force. Using the above example of a 5N predefined threshold, for instance, the piezoelectric sensor could tolerate the consistent application of force due a tolerance error. Unlike an FSR sensor, the piezoelectric sensor essentially just “zeros out” and responds to the application of a further 5N applied force in a predictable manner.

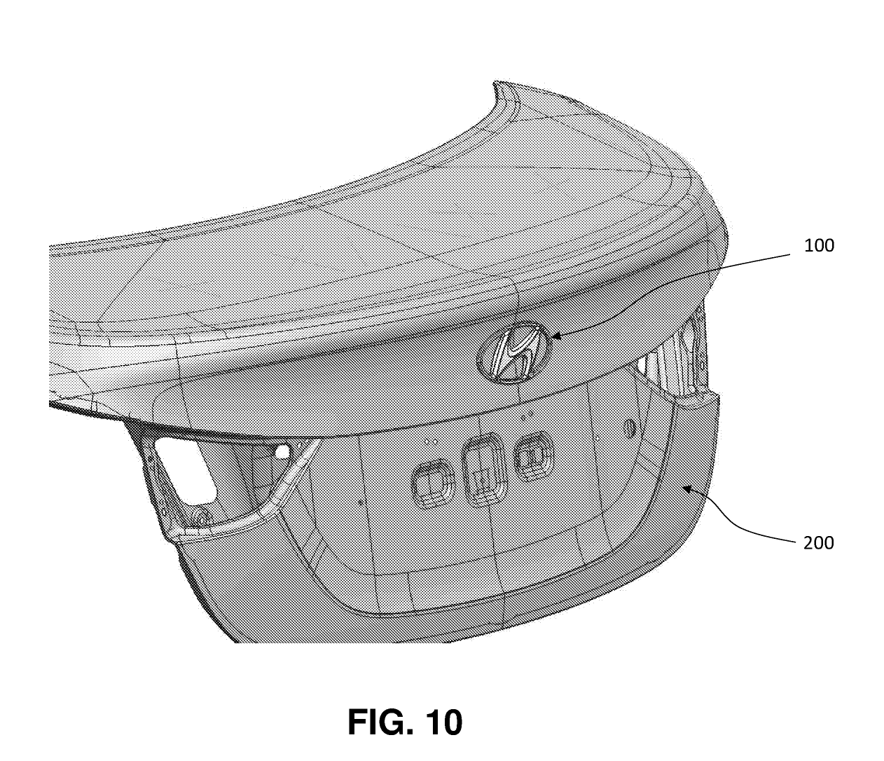

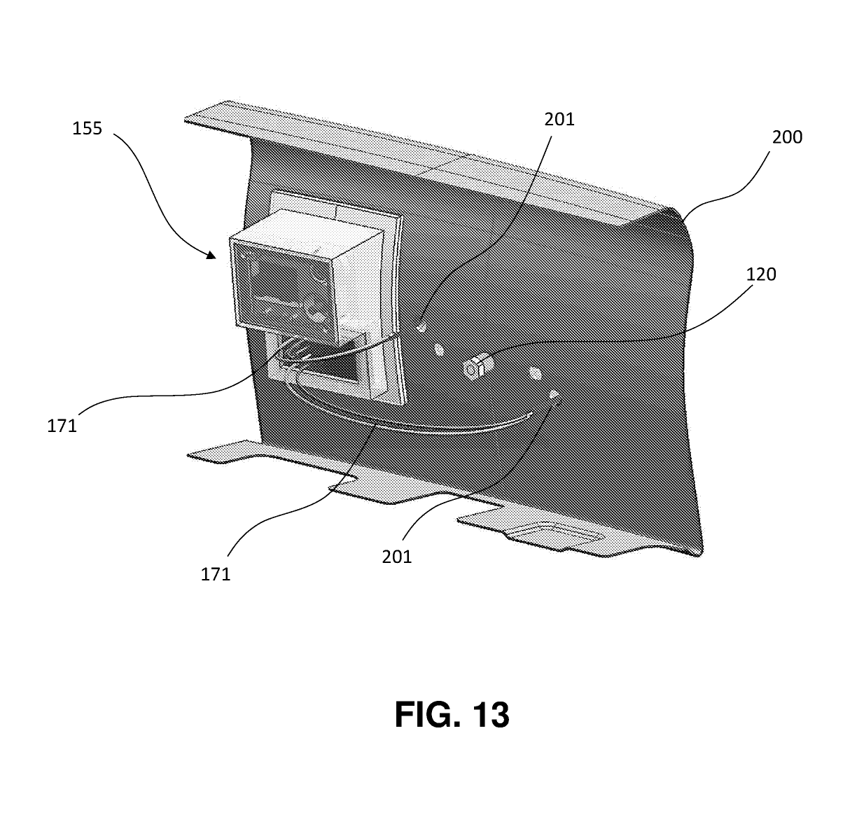

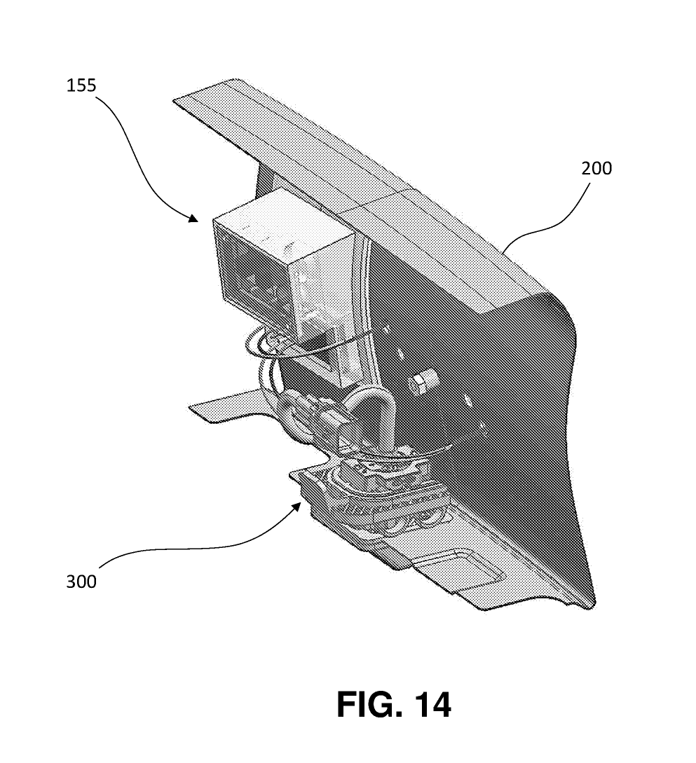

Turning next to FIGS. 10-14, there is shown an embodiment of the present invention in which the force transfer member may take the form of a moveable component, such as the trim component—including, by way of non-limiting example, the decorative emblem (comprising, for instance, the logo of the vehicle manufacturer) 100—on the trunk closure 200 (only the sheet metal portion is depicted) of a vehicle. Of course, the emblem 100 is only exemplary, and it will be understood that the moveable component may be one or more other components of the vehicle or vehicle closure.

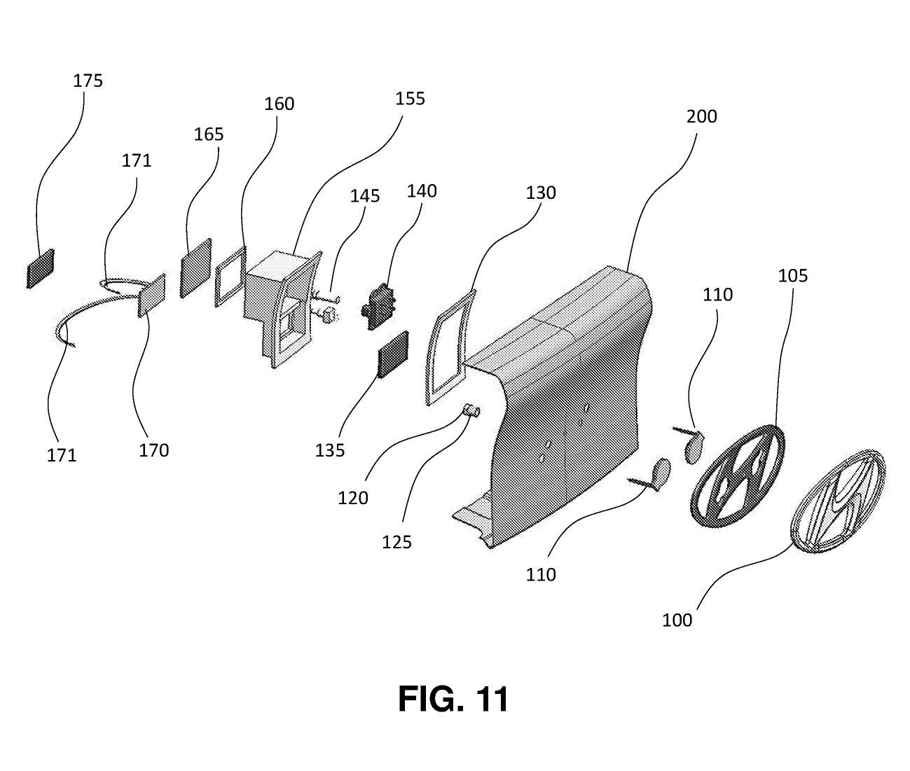

Referring also to FIGS. 11-14, the closure control will be seen to include the force transfer member in the form of the emblem 100 which is mounted to the trunk closure 200 by means of a retaining post 120 extending through the material (e.g., sheet metal) of the trunk closure 200. A spring 125 or other biasing member disposed on the retaining post 120 may be employed to urge emblem 120 to a default position which leaves room for movement of emblem 100 in the manner described herein. On the exterior of the trunk closure 200, emblem 100 is positioned over a resiliently compressible gasket 105. In the illustrated embodiment, gasket 105 is of a shape complimentary to the emblem 100 so as to be substantially hidden thereby. Gasket 105 alone may be sufficiently resilient as to bias the emblem 100 into the default position thereof.

According to the illustrated embodiment, two sensor buttons 110 are positioned on an interior (i.e., trunk-closure facing) surface of the emblem 100. Openings through the gasket 105 permit the sensor buttons 110 to contact the exterior surface of the trunk closure 200 beneath the emblem 100. In the illustrated embodiment, each sensor button 110 comprises an FSR sensor, including its associated circuit board. However, it is also contemplated that each sensor button 110 could be a piezoelectric sensor or, alternatively, another type of sensor capable of performing essentially in the manner herein described. Likewise, while two sensor buttons 100 are shown and described in the illustrated embodiment, it will be appreciated from this disclosure that one or, alternatively, more than two such sensor buttons may also be adapted to the present invention.

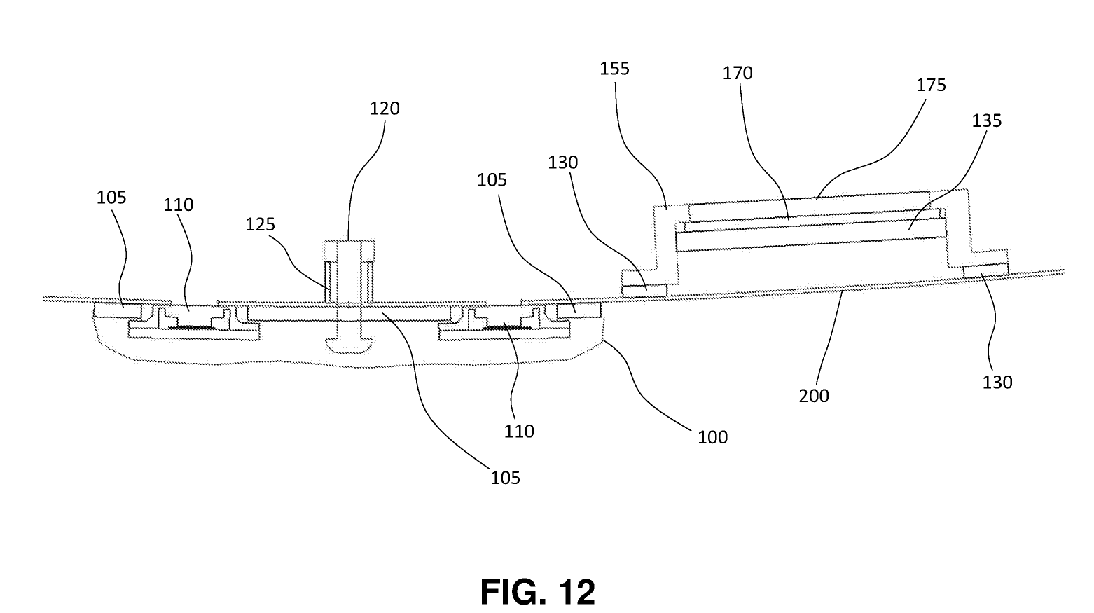

With particular reference to FIG. 12, it will be seen that emblem 100 is movable with respect to the trunk closure 200; that is, emblem 100 may be pressed or pushed by a user toward the trunk closure 200 and into the gasket 105. When such pressure ceases, the spring 125 and gasket 105 tend to bias the emblem 100 back to its default position. As explained further hereinbelow, such application of pressure on the emblem 100 is transferred to the force sensing members (i.e., the sensor buttons 110 in the illustrated embodiment) so as to effect the execution of one or more of the pre-defined vehicle commands, such as, for instance, actuation of the trunk closure latch mechanism.

According to this embodiment of the invention, it is contemplated that the emblem 100 is a rigid material (such as chromed plastic or metal, for instance). However, it is also contemplated that, instead of the arrangement described, emblem 100 could be fashioned from a resiliently deformable material so as to transfer to the one or more sensor buttons 110 the force of user pressure applied thereto, including in a manner such as described herein.

Referring also to FIGS. 10, 11, 13 and 14, there is mounted on an interior surface of the trunk closure 200 a housing 155 in which is disposed a controller 170, one or more switches 140, and, optionally, one or more lights 145 (such as LEDs, for instance). Housing 155 is sealed against the interior surface of the trunk closure 200 by means of a gasket 130. Controller 170, which comprises a printed circuit board (PCB), is disposed in one section of the housing 155 between potting material 135, 175. Wires 171 extend between the controller 170 and each of the sensor buttons 110 through openings 201 in the trunk closure 200. In another section of the housing 155 is disposed the one or more switches 140 and the optional one or more lights 145. A cover 165 is secured to the housing 155 to close this section of housing 155, with a gasket 160 being disposed between the cover 165 and housing 155.

The controller 170 is coupled to a suitable power source (which may be a local power source, such as a battery, or a remote power source, such as the vehicle's battery), and may also be coupled to one or more other controllers, such as the vehicle's body control module, for effecting, in otherwise known fashion, the vehicle commands as determined by the controller. That is, controller 170 may signal the remotely positioned controller to effect the one or more vehicle commands. Alternatively, or in addition, it will be appreciated that controller 170 may also be programmed to effect the pre-defined vehicle commands in response to inputs from the one or more sensor buttons 110.

As with other embodiments of the invention as described herein, a haptic actuator (not shown) may also be provided to give user feedback, such as a physical vibration of the emblem 100 or other force transfer member, upon a user's application of force thereto.

According to one form of this embodiment of the present invention, controller 170 is simply operative to respond to inputs from one or both sensor buttons 110—indicating that one or both buttons 110 has been subject to force as a result of a user's pushing or pressing on the emblem 100—by effecting actuation of the trunk closure latch mechanism 300. As noted above, such actuation may be effected directly by the controller 170 or, alternatively, controller 170 may be wired to communicate with another controller of the vehicle, such as the vehicle's body control module, which is itself operative to effect actuation of the trunk closure latch mechanism in response to a signal from the controller 170.

Likewise, it is contemplated that the controller 170 may also be in communication with switches elsewhere in or outside of the vehicle to effect actuation of the trunk closure latch mechanism 300 or other vehicle command. For instance, and not by way of limitation, controller 170 may be responsive to a switch in the passenger cabin to actuate the trunk closure latch mechanism.

As with other embodiments of the invention, the controller 170 may be programmed to associate different signals from the one or more sensor buttons 110 (whether they are FSRs, piezoelectric sensors, etc.) with one or more pre-defined vehicle commands. Thus, for instance, the brief application of force on the emblem 100 by a user will result in the sensor buttons 110, or either of them, generating only a short signal. That short signal may be distinguished from the longer signal generated by one or both sensor buttons 110 when a user applies force to the emblem 100 for a longer period of time. These different signal durations may be assigned to effect different vehicle commands via the controller 170. For example, the shorter duration signal may be associated with a controller 170 command to open the trunk closure latch mechanism 300, while the longer duration signal may be associated with a controller 170 command to place the latch mechanism 300 in a locked state. Alternatively, or in addition, the controller 170 may also be programmed to associate the sequence of signals (of the same or different durations) with different commands. For instance, where the trunk closure latch mechanism 300 is in one state (e.g., locked), a subsequent application of force on the emblem 100 by a user may place the trunk closure latch mechanism in an unlocked state. Thereafter, the next application of force on the emblem 100 by a user may result in the trunk closure latch mechanism 300 being placed back into the locked state.

As will be appreciated, the employment of more sensors in the foregoing embodiment permits a correspondingly greater variety of signals to be generated through user contact with the force transfer member and, therefore, a greater number of vehicle actions to be effected through the correlation of such signals with a variety of pre-defined vehicle commands.

Advantageously, the foregoing embodiment of the present invention will be understood to permit a user to effect one or more pre-defined vehicle commands (such as, for instance, unlatching the vehicle trunk) by contacting the force transfer member (e.g., the emblem 100) other than with their hand. Thus, for instance, the user could push or press the emblem 100 with their foot, elbow, hip, rear end, etc. This is particularly beneficial where the user's hands are otherwise occupied (for instance, carrying groceries or luggage to the vehicle to put in the trunk).

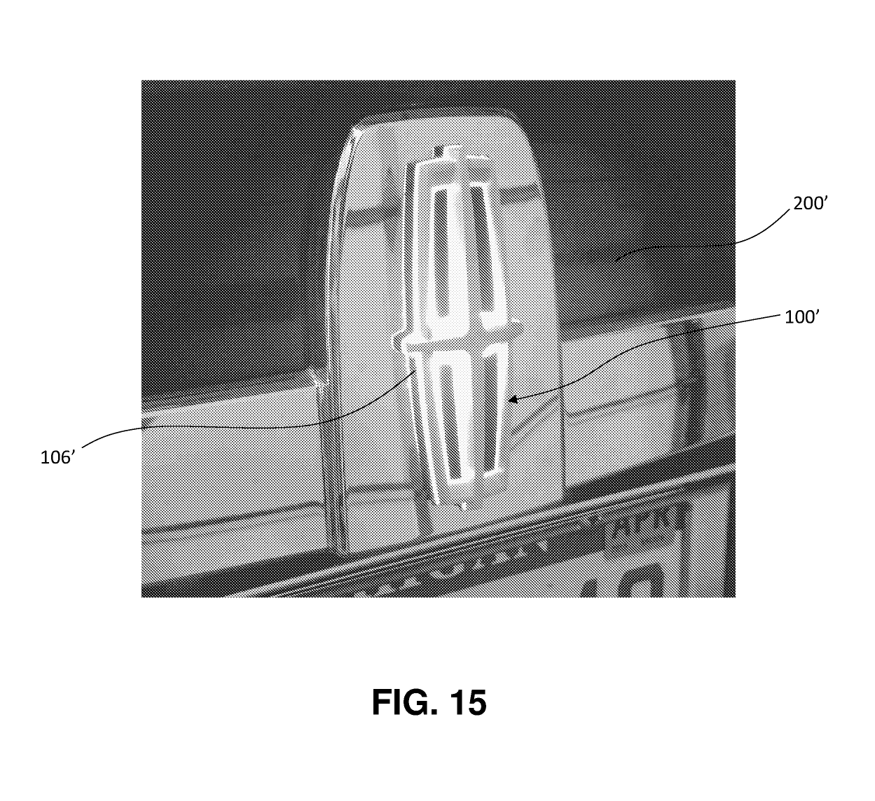

As noted, one or more lights 145 may optionally be provided to provide illumination in response to user-actuation of the force transfer member (e.g., the emblem 100, thereby giving the user an indication of successful actuation of the closure control. As likewise noted, other feedback means—such as, by way of non-limiting example, a haptic device, a speaker (e.g., piezoelectric speaker) for emitting an audible signal—may be employed additionally or in the alternative. Where one or more lights are employed, the means of illumination may take any of a variety of forms. For instance, the one or more lights may be associated with a light pipe or lens positioned adjacent the force transfer member. In one exemplary form, shown in FIG. 15, a light-pipe 106′ or other light-transmitting member of substantially the same shape as the emblem 100′ is disposed between the emblem 100′ and the gasket. The light-pipe 106′ is associated with the one or more lights disposed inside the trunk closure 200′ so as to distribute the light from the one or more lights upon illumination thereof.

In any of the foregoing embodiments, it will be appreciated that the controller 170 is programmed to actuate the one or more lights to provide the desired illumination when, in response to user actuation of the force transfer member, a pre-defined vehicle command (such as unlatching of the closure) is effected.

Likewise, it will be appreciated that the one or more lights may be capable of illumination in more than one color, and that the controller 170 may be programmed to effect selective illumination of each of the one or more colors of lights for each of distinct pre-defined vehicle commands. For instance, illumination in a first color (e.g., green), may indicate that the closure control has been actuated to effect unlocking of the trunk closure latch mechanism, while illumination in a second color (e.g., red) may indicate that the closure control has been actuated to effect locking of the trunk closure latch mechanism.

Still further, it is contemplated that the controller 170 may be operative (either itself or via communication with the vehicle's body control module) to effect illumination (including in a specific color) of the one or more lights when the presence of the user is detected in proximity of the vehicle through the detected presence of an authorized key fob remote or, alternatively, when the user actuates one or more buttons on the key fob remote.

With respect to the aforedescribed embodiments, and most especially when FSR sensors are employed, it is contemplated that the controller may be programmed to accept a pre-defined range of intensities and locations defined around a specific intensity and location nominally constituting the force profile necessary to effect an associated vehicle command. In this fashion, the invention recognizes various combinations of force intensities and locations within the pre-defined range of intensities and locations, thereby permitting user actuation of the vehicle closure control even when the nominal force profile is not exactly met. Furthermore, the controller may be programmed to learn the “activation threshold” for each pre-defined force profile. In other words, the controller may be programmed to set each pre-defined force profile, from among the various combinations of force intensities and locations within the pre-defined range of intensities and locations, according to the particular intensity and location of the force applied thereto by one or more users. Alternatively, or in addition, it is contemplated that the controller may be programmed to learn each pre-defined force profile by one or more users, and to have those learned force profiles associated with one or more vehicle commands. So, by way of non-limiting example, it is contemplated that a vehicle user could, by any of various means, enter a “learning” mode of the closure control, from which mode the user would be directed to touch the door handle to effect the transfer of force through any of the one or more force transfer members provided in order to create a force profile to associate with a pre-defined vehicle command. Still more particularly, the user might be instructed to enter, in the foregoing fashion, a force profile for the command effecting the unlocking of the vehicle. In response to that instruction, the user would then tough or grab the handle, via any of the one or more force transferring members, to define the force profile to associate with that vehicle command. The controller would then memorize the map of that particular force profile and associate it with the vehicle “unlock” command. It will be appreciated that, using smart “key fob” technology, whereby a vehicle may be programmed to recognize different vehicle users through distinct “key fob” codes and associate each such user with particular vehicle settings, that the controller may likewise be modified to associate, through the same technology, individual vehicle users with unique force profiles learned in the manner heretofore described.

It is important to note that the construction of the present invention as shown and described in this specification is illustrative only. And although several embodiments of the present invention are described in detail herein, those skilled in the art will appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple elements may be integrally formed, the operation of the interfaces may be reversed or otherwise varied, the length of width of the structures and/or members or connector or other elements of the system may be varied. It is also be noted that the elements and/or assemblies of the exemplary embodiments may be constructed from any of a wide variety of material that provide sufficient strength or durability, in any of a wide variety of colors, textures and combinations. Accordingly, all such modifications are intended to be included within the scope of the present innovations. Other substitutions, modifications, changes and omissions may be made in the design, operating conditions and arrangement of the preferred and other exemplary embodiments without departing from the spirit of the present invention.

The invention in which an exclusive property or privilege is claimed is defined as follows:

1. A user-actuatable vehicle closure control, comprising:
at least one force sensing member disposed beneath at least one force transfer member, the at least one force sensing member operative to detect the application of force thereto, and the force transfer member moveable upon user application of force thereto so as to transfer the user-applied force to the at least one force sensing member; and
a controller operatively connected to the at least one force sensing member, the controller operative to direct the execution of one or more pre-defined vehicle commands in response to one or more signals from the at least one force sensing member indicating the application of force thereto by a user via the force transfer member.

2. The vehicle closure control of claim 1, wherein the force transfer member is a trim component.

3. The vehicle closure control of claim 2, wherein:
The trim component is movably mountable to a closure so as to be capable of being temporarily pressed or pushed by a user toward the closure from a first position;
Wherein the at least one force sensing member comprises at least one sensor button positioned on a surface of the trim component facing the closure so as to detect the application of force thereto when the trim component is temporarily pressed or pushed by a user toward the closure;
An housing mountable on an interior surface of the closure, the housing containing the controller;
The controller connectable to a power source and operatively connectable to a latch mechanism for the closure, and the controller operatively connected to the at least one sensor button so as to receive the one or more signals indicating the application of force to the at least one sensor button, and;
Wherein the controller is operative, in response to one or more signals from the at least one sensor button indicating the application of force thereto by a user via the trim component, to at least effect actuation of the closure latch mechanism.

4. The vehicle closure control of claim 3, wherein the closure is a trunk closure and the trim component is a decorative emblem for the trunk closure.

5. The vehicle closure control of claim 3, wherein the trim component is biased into the first position.

6. The vehicle closure control of claim 3, wherein the controller comprises a printed circuit board.

7. The vehicle closure control of claim 3, wherein each at least one sensor button comprises a piezoelectric sensor.

8. The vehicle closure control of claim 3, further comprising a resiliently compressible gasket mountable between the trim component and the closure, the gasket having a shape complimentary to the trim component so as to be substantially hidden thereby.

9. The vehicle closure control of claim 3, wherein the one or more signals from the at least one sensor button comprise signals of varying duration according to the duration of the force applied thereto via movement of the trim component toward the closure, and wherein further the one or more pre-defined vehicle commands include unique commands associated with the one or more signals according to their duration.

10. The vehicle closure control of claim 9, wherein the controller is operative to effect unlatching of the closure latch mechanism in response to signals of a first duration, and to effect placing the closure latch mechanism in a locked state in response to signals of a second duration which is different than the first duration.

11. The vehicle closure control of claim 3, wherein the one or more pre-defined vehicle commands include unique commands associated with the one or more signals according to the sequence in which the one or more signals are received by the controller.

12. The vehicle closure control of claim 11, wherein the controller is operative to effect unlatching of the closure latch mechanism in response to the first signal received after the closure latch mechanism is in a locked state, and to effect placing the closure latch mechanism in a locked state in response to the first signal received after the closure latch mechanism is unlatched.

13. The vehicle closure control of claim 3, further comprising one or more lights operatively connected to, and selectively illuminated by, the controller.

14. The vehicle closure control of claim 13, wherein the one or more lights are illuminated when the controller directs the execution of one or more of the pre-defined vehicle commands.

15. The vehicle closure control of claim 14, wherein the one or more lights are capable of illumination in more than one color, and wherein further the controller is programmed to effect selective illumination of one or more different colors for each of distinct ones of the pre-defined vehicle commands.

16. The vehicle closure control of claim 14, wherein the controller is operative to effect illumination of the one or more lights in a first color when the controller has effected unlatching of the closure latch mechanism, and to effect illumination of the one or more lights in a second color that is different from the first color when the controller has effected placing the closure latch mechanism in a locked state.

17. The vehicle closure control of claim 13, wherein the one or more lights are associated with a light-transmitting member positioned adjacent the trim component.

18. The vehicle closure control of claim 17, wherein the light-transmitting member is substantially disposed on a surface of the trim component facing the closure, and wherein the one or more lights are disposed in the housing and are associated with the light-transmitting member to as to convey illumination to the light-transmitting member.

19. The vehicle closure control of claim 3, further comprising one or more speakers operatively connected to the controller, and wherein the controller is programmed to effect selective emission of an audible signal from the one or more speakers for each of distinct ones of the pre-defined vehicle commands.
